(19) United States
(12) Patent Application Publication
(10) Pub. No.: US 2005/0250462 A1
(43) Pub. Date: Nov. 10, 2005

(54) Gain control circuit

(75) Inventors: YanYan Wu, Berkshire (GB); Derya Olgen, Surrey (GB); Ken Mason, Hampshire (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/643,364

(22) Filed: Aug. 19, 2003

(30) Foreign Application Priority Data
Aug. 20, 2002 (GB) 0219289.6

(51) Int. Cl. H04B 1/06

(52) U.S. Cl. 455/234.1; 455/232.1

(57) ABSTRACT

An automatic gain control circuit is used to vary the gain of a low noise amplifier and baseband amplifiers in a direct conversion receiver in a mobile telephone handset. The automatic gain control circuit is configured to cause a power level (57) of a signal supplied to an analog-to-digital converter having a signal-to-noise ratio of 33 dB to converge on a reference level (49) using a two-stage process.

The present invention relates to a gain control circuit, particularly, although not exclusively, for a direct conversion receiver in a mobile communications device.

It is well known to provide automatic gain control in radio receivers. The need for automatic gain control arises because components within a radio receiver usually have a limited dynamic range. If an amplified signal is fed into a component and the signal level exceeds the dynamic range, then the component will saturate. Conversely, if a signal is not sufficiently amplified such that the amplified signal level falls below a threshold level, then the component will fail to detect the amplified signal. Thus, automatic gain control is used to align amplified signal levels with the dynamic ranges of the components.

Ideally, automatic gain control should be able to handle large and rapid signal variations. In practice, however, automatic gain control is usually slow or limited. It is possible to compensate for slow or limited automatic gain control by increasing the dynamic ranges of the components used in a receiver. However, this solution is costly.

The present invention seeks to overcome this problem and provide an improved gain control circuit.

According to the present invention there is provided a gain control circuit for causing a power level of a signal to converge on a power level reference signal, said circuit being arranged, in a first adjustment, to determine whether the power level of said signal falls within a predetermined range containing the power level reference signal and, if not, to adapt said signal in a manner predetermined to cause the power level of said adapted signal to fall within said predetermined range and, in a second adjustment, to measure the power level of said adapted signal and to further adapt said adapted signal using the measured power level of said adapted signal thereby causing the power level of said further adapted signal to converge on the power level reference signal.

The predetermined range may be a dynamic range of an electric component or circuit.

The gain control circuit may be configured to cause the power level of the signal to converge on the power level reference signal using no more than tvo adjustments

The gain control circuit may be arranged such that convergence of the power level of the signal on the power level reference signal is achieved by adapting said signal in the predetermined manner and further adapting the adapted signal. The gain control circuit may be arranged to determine whether the power level of said signal falls within the predetermined range containing the power level reference signal by checking whether the power level has clipped.

The gain control circuit may be arranged to determine whether the power level of said signal falls within the predetermined range containing the power level reference signal by determining whether an average power level of said signal falls within another predetermined range. The another measurement range may provide a measurement range limit tolerance to take account of signalling averaging errors. The gain control circuit may be arranged to adapt the power level of said signal by a predetermined amount. The gain control circuit may be arranged to adapt the power level of said signal by causing a change in gain by a predetermined factor. The gain control circuit may be arranged to adapt the power level of said signal by selecting a one of a plurality of fixed gains of an amplifier. The gain control circuit may be arranged to adapt the power level of said signal by selecting a one of three fixed gains of an amplifier. The gain control circuit may be arranged initially to select a first fixed gain having an intermediate gain and thereafter to adapt the power level of said signal by selecting a second, lower or a third, higher fixed gain. The gain control circuit may be arranged to measure the power level of said adapted signal by comparing the power level of said adapted signal with the power level reference signal so as to determine an error value. The gain control circuit may be arranged to further adapt said adapted signal by causing a change in gain related to the error value. The gain control circuit may be arranged to adapt said signal using a relatively coarse adjustment and to further adapt said adapted signal using a relatively fine adjustment.

The signal may include first and second consecutive signal portions and the gain control circuit may be arranged to determine during the first signal portion whether the power level of said signal falls within the predetermined range containing the power level reference signal and, if not, to adapt said signal in the predetermined manner thereby causing the power level of said adapted signal to fall within said predetermined range and to measure during the second signal portion the power level of said adapted signal and to further adapt said adapted signal using the measured power level of said adapted signal thereby causing the power level of said further adapted signal to converge on the power level of said reference signal.

The gain control circuit may be for controlling first and second amplifiers and may include first and second outputs for controlling gains of said first and second amplifiers respectively. The gain control circuit may be configured to instruct said first amplifier to change gain so as to adapt said signal in the predetermined manner and may be configured to instruct said second amplifier to change gain so as to further adapt said adapted signal. The gain control circuit may be configured to instruct said first amplifier to change gain only once during said first and second adjustments.

The measurement range may be a range which is reliably measured and may include a positive limit and a zero limit or a positive limit and a negative limit. The gain control circuit may be arranged, in the first adjustment, to appropriately adapt said signal by an amount corresponding to a standard/product defined maximum magnitude of the signal outside a proximal measurement range limit so as to bring the signal within the measurement range. To appropriately adapt is to modify the signal according to whether the signal is under-saturated or over-saturated. The gain control circuit may conform to a 1^{st}, 2^{nd}, 3^{rd} or 4^{th} generation telecommunications standard, or a derivative standard, and a maximum standard/product defined signal magnitude may be derived from said standard. The gain control circuit may be arranged, in the first adjustment, to adapt said signal by a different amount according to which predetermined range limit the signal is outside.

According to the present invention there is also provided a radio receiver including a gain control circuit and first and second amplifiers.

The radio receiver may be configured to instruct said first amplifier to change gain so as to adapt said signal in the predetermined manner. The radio receiver may be configured to instruct said second amplifier to change gain so as to further adapt said adapted signal. The radio receiver may be configured to instruct said first amplifier to change gain only once before the power level of said signal converges on the power level of said reference signal. The signal may comprise the output of said second amplifier. The first amplifier may be a radio frequency amplifier, such as a low noise amplifier. The second amplifier may be a baseband amplifier. An output of said second amplifier may feed into a component, such as an analog-to-digital converter. The gain control circuit may be arranged to determine whether the power level of said signal falls within the predetermined range by checking whether an output of said component has clipped. The gain control circuit may be arranged to check a predetermined number of samples of said output of said component. The first amplifier may have a plurality of selectable fixed gains. The second amplifier may have a plurality of selectable fixed gains. The first amplifier may have three selectable fixed gains. The gain control circuit may be arranged initially to configure the first amplifier to have a first fixed gain which is higher than a second fixed gain and lower than a third fixed gain. The gain control circuit may be arranged initially to configure the second amplifier to have a gain which is substantially half way between a lowest selectable gain and a highest selectable gain. The gain control circuit may be arranged to adapt the power level of said signal by selecting said second or third fixed gain of said first amplifier. The gain control circuit may be arranged to measure the power level of the adapted signal by comparing the power level of said adapted signal with the power level reference signal so as to determine an error value. The gain control circuit may be arranged to take a predetermined number of samples of power level of said adapted signal. The gain control circuit may be arranged to take an average of said predetermined number of samples. The gain control circuit may be arranged to determine said error value using said average of said predetermined number of samples. The gain control circuit may be arranged to further adapt said signal by adjusting the gain of the second amplifier. Adjustment of the gain of the second amplifier may be related to error value. The radio may further comprise a third amplifier. The signal may comprise an average of respective outputs of said second and third amplifiers. The gain control circuit may arranged to adjust the gains of the second and third amplifiers. The radio receiver may receive a radio signal comprising first and second consecutive radio signal portions corresponding to said first and second signal portions.

The radio signal portions may comprise encoded symbols. The radio receiver may be for use in a radio network conforming to a third generation radio standard. The radio receiver may be for use in a code division multiple access (CDMA) radio network. The radio receiver may be for use in a wideband code division multiple access (WCDMA) radio network.

According to the present invention there is also provided a method of gain control for causing a power level of a signal to converge on a power level reference signal, the method comprising in a first adjustment: determining whether the power level of said signal falls within a predetermined range containing the power level reference signal and, if not, adapting said signal in a manner predetermined to cause the power level of said adapted signal to fall within said predetermined range and, in a second adjustment: measuring the power level of said adapted signal and further adapting said adapted signal using the measured power level of said adapted signal thereby causing the power level of said further adapted signal to converge on the power level of said reference signal.

According to the present invention there may also be provided a computer program for performing the method.

An embodiment of the present invention will now be described, by way of example, with reference to the accompanying drawings in which:

FIG. 1 is illustrates a mobile telephone handset;

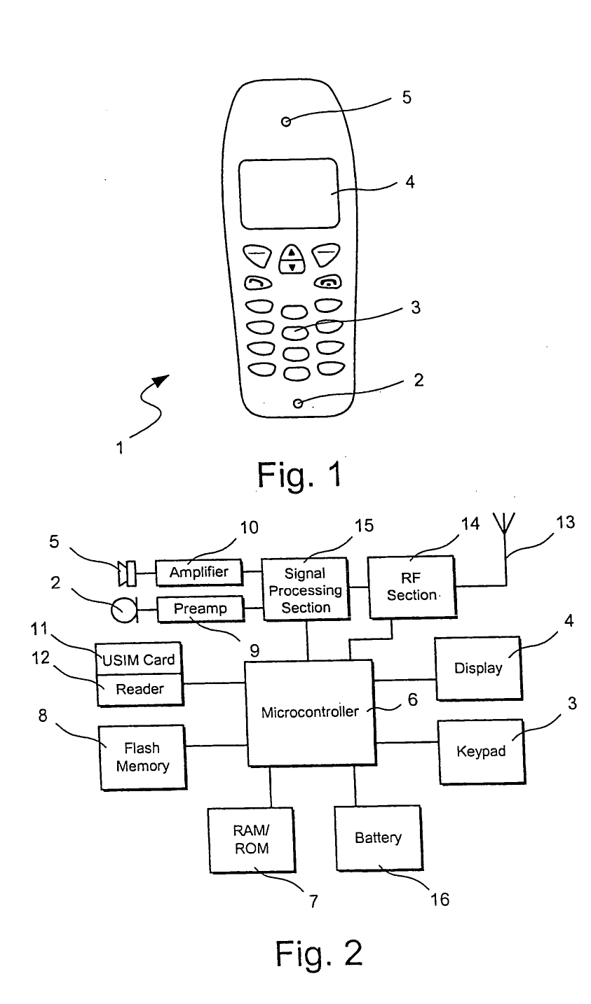

FIG. 2 is a schematic block diagram of the circuitry of the mobile telephone handset shown in FIG. 1;

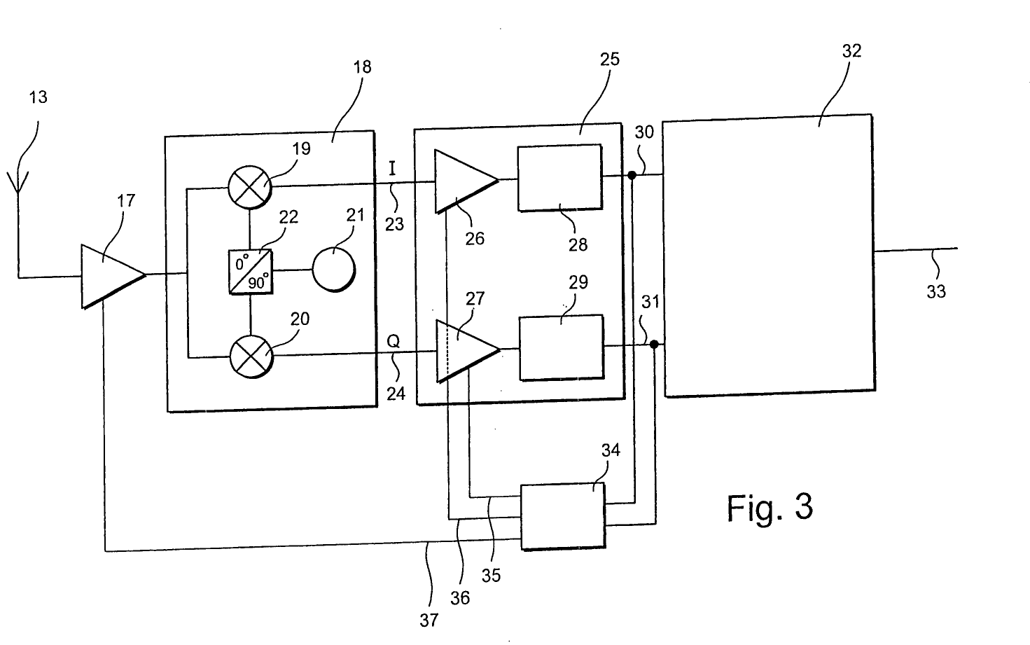

FIG. 3 is a block diagram of a direct conversion receiver included in the mobile telephone handset shown in FIG. 1;

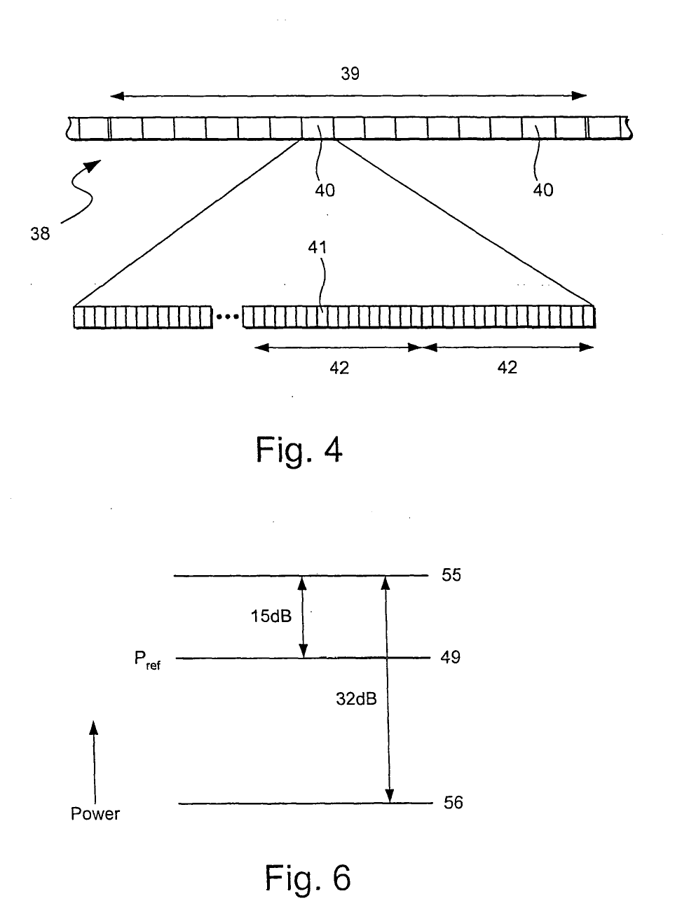

FIG. 4 illustrates a radio channel for receiving by the direct conversion receiver shown in FIG. 3;

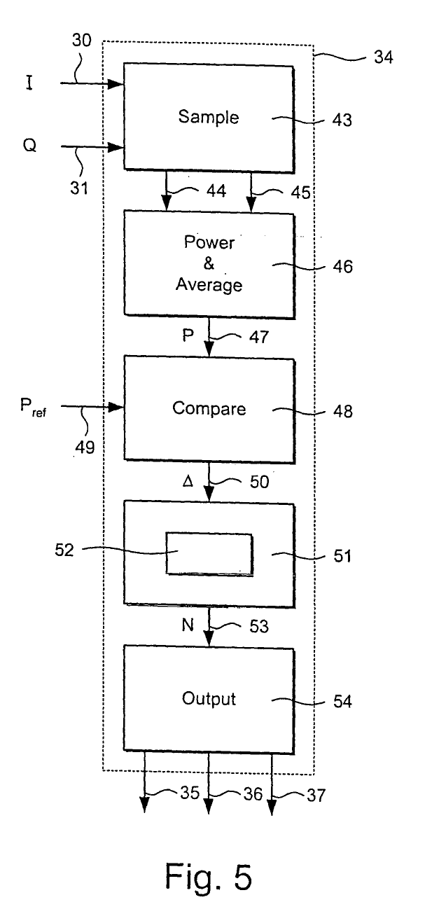

FIG. 5 is a block diagram of an automatic gain control circuit included in the direct conversion receiver shown in FIG. 3;

FIG. 6 shows a dynamic range of an analog-to-digital converter included in the direct conversion receiver;

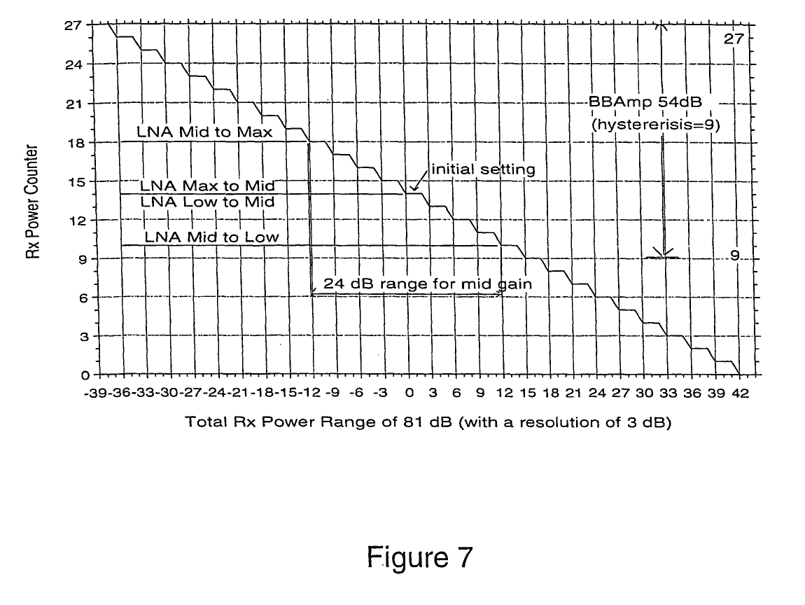

FIG. 7 shows a relationship between a counter included in the automatic gain control circuit and power received by an analog-to-digital converter;

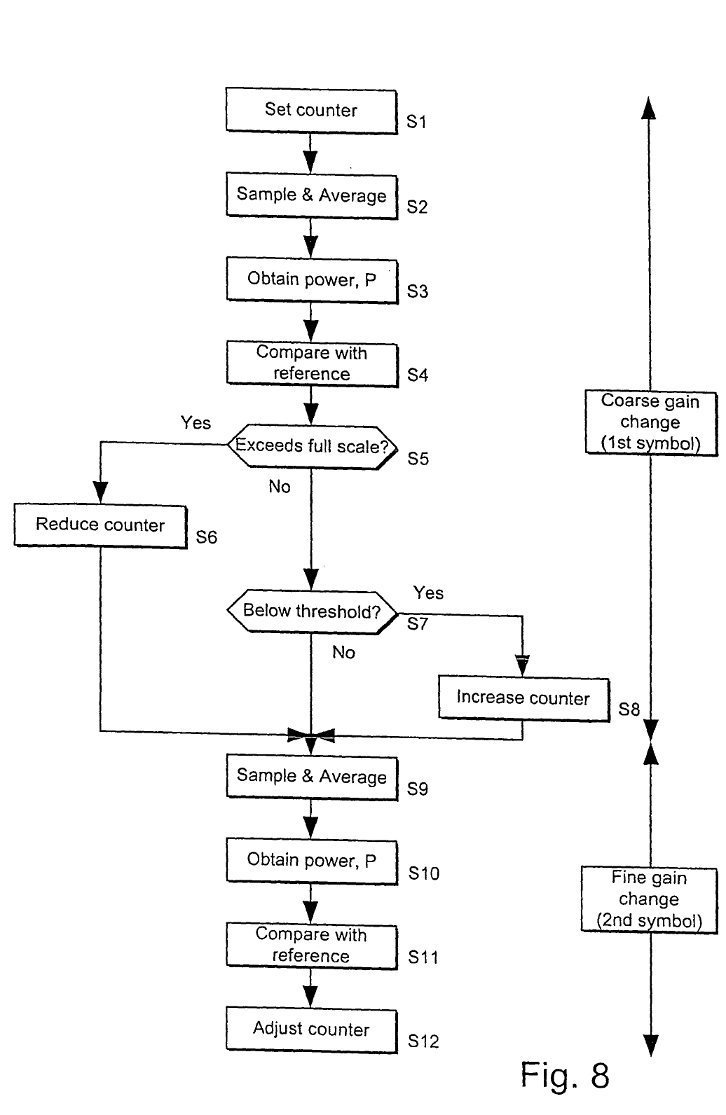

FIG. 8 is a process flow diagram by which an automatic gain control circuit operates; and

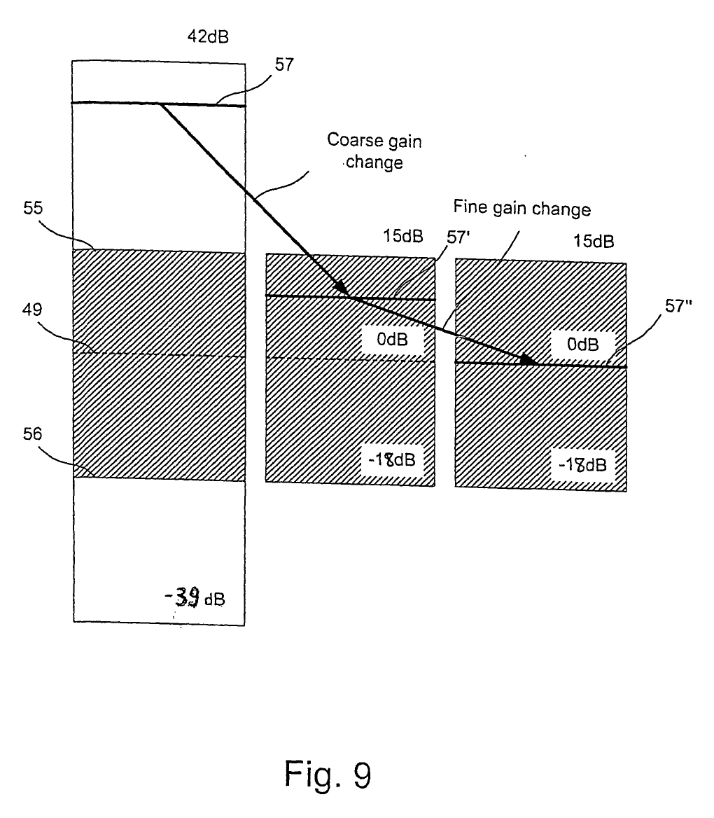

FIG. 9 illustrates a two-stage automatic gain control process.

FIG. 1 shows a mobile communications device in the form of a mobile telephone handset 1, which is sometimes referred to as a cellular telephone handset. The handset 1 includes a microphone 2, keypad 3, liquid crystal display (LCD) 4 and speaker 5. The handset 1 conforms to a so-called “third generation” standard. In this example, the handset 1 is used in a wideband code division multiple access (W-CDMA) system and is suitable for frequency division duplex (FDD) and time division duplex (TDD) modes of transmission. In third generation nomenclature, the handset 1 is referred to as user equipment (UE).

FIG. 2 illustrates circuitry included in the handset 1. Signal processing is carried out under the control of a digital microcontroller 6 which has an associated RAM/ROM 7 and flash memory 8. Electrical analogue audio signals are produced by the microphone 2 and amplified by a pre-amplifier 9. Similarly, analog audio signals are fed to the speaker 5 through an amplifier 10. The microcontroller 6 receives instruction signals from the keypad 3 and controls operation of the LCD 4 and flash memory 8.

Information concerning the identity of the user is held on a Universal Subscriber Identity Module (USIM) 11 which is removably received in a card reader 12. Radio signals are transmitted and received by means of the antenna 13 connected through an r.f. section 14 to a signal processing section 15 configured to process signals under the control of a microcontroller 6.

In use, for speech, the signal processing section 15 receives analogue signals from the microphone amplifier 9 and carries out a plurality of processes. These processes include digitisation of the analog signals, variable-rate speech encoding, channel coding, during which error protection and control data is included, and channel spreading. The signal processing section 15 feeds data for transmission to the r.f. section 14 for modulation, in this case using Quadrature Phase Shift Keying (QPSK) modulation, amplification and transmission through antenna element 13 to a radio base station (not shown), referred to as a Node B, located in an UMTS terrestrial radio access (UTRA) network (not shown).

Similarly, signals received from the UTRA network (not shown) are fed through the antenna element 13 to be demodulated by the r.f. section 14 and fed to signal processing section 15 for de-spreading and decoding so as to produce analogue signals which are fed into amplifier 10 and into the speaker 5. The handset 1 is powered by a battery 16.

Referring to FIG. 3, the r.f. section 14 (FIG. 2) includes a direct conversion receiver which performs a method of gain control according to the present invention.

The direct conversion receiver includes a radio frequency amplifier in the form of a low noise amplifier (LNA) 17. The LNA 17 receives input signals from antenna 13 via a duplexer (not shown) and feeds a mixer circuit 18 which comprises first and second mixers 19, 20, a local oscillator 21 and a phase shifter 22. The output of the LNA 17 is connected to respective first inputs of the mixers 19, 20. The output signal from the local oscillator 21 is fed into a respective first input of the phase shifter 22. First and second outputs of the phase shifter are connected to respective second inputs of the mixers 19, 20. The respective outputs 23, 24 of the mixers 19, 20 are connected to a baseband circuit 25 which includes first and second baseband amplifiers 26, 27 and first and second analog-to-digital converters 28, 29. The respective outputs 30, 31 of the analog-to-digital converters 28, 29 are fed into a demodulator 32, the output of which presents a demodulated signal 33 to the signal processing section 15 (FIG. 2). In this example, the analog-to-digital converters 28, 29 have a 6-bit output.

The direct conversion receiver is provided with an automatic gain control circuit 34 for setting the gain of LNA 17 and baseband amplifiers 26, 27 through control lines 35, 36, 37. Preferably, the automatic gain control circuit is implemented in hardware. This has the advantage of speed. Alternatively, the automatic gain control circuit may be implemented as a virtual circuit in software.

The analog-to-digital converters 28, 29 have a limited dynamic range. In this example, the signal-to-noise ratio of each analog-to digital converter 28, 29 is 33 dB. Although the analog-to-digital converters 28, 29 have a limited dynamic range of 33 dB, a signal fed into the analog-to digital converters 28, 29 may have a power within a 81 dB range. An upper end of the signal range may correspond to a standard and/or product defined maximum signal level, in this case 42 dB, and a lower end of the signal range may correspond to a standard/product defined minimum signal level, in this example −39 dB. The signal range may be defined in accordance with a telecommunications standard, in this case a 3g standard. Thus, it is desirable for the automatic gain control circuit 34 to able to adjust the power of the signal fed into the analog-to-digital converters 28, 29 by controlling gain of the amplifiers 17, 26, 27 so as to match the power of the signal with the dynamic range of the converters 28, 29. In an embodiment of the present invention, this is achieved using a two-stage method comprising coarse and fine steps.

Referring to FIG. 4, the handset 1 (FIG. 1) communicates with the UTRA network (not shown) via a radio channel 38 which may be used both to transmit and receive data. User data in the radio channel 38 is spread using a relatively high-rate pseudo-random bit stream, called a spreading code. Data bits within the spreading code are usually referred to as chips. The channel 38 is divided into frames 39 and each frame 39 is further divided into a plurality of timeslots 40. For TDD WDCMA, the channel 38 has a bandwidth of 5 MHz and a chip rate of 3.84 Mcps, while each frame 39 has a period of 10 ms and is divided into 15 timeslots. Each slot 39 may be used to transmit user data and control data and comprises a plurality of chips 41. Data is transmitted in the form of symbols 42, with each symbol 42 being represented by a predetermined number of chips 41, for example 16 chips.

A general description of the radio interface is given in 3^{rd} Generation Partnership Project Technical Specification 25.201 V.5.0.0 (2001-12) and Technical Specifications referred to therein and also in Chapter 4 of “The UMTS Network and Radio Access Technology” by Jonathan P. Castro Cohn Wiley & Sons, Ltd. Chichester, 2001).

At the handset 1, power level varies from one slot to the next and may vary by as much as 40 db. This may arise due changes in the number of users allocated to share a particular timeslot and also due to channel fading.

Apparatus which is used to adjust the power of the signal fed into the analog-to-digital converters will now be described in more detail:

Referring to FIG. 5, the automatic gain control circuit 34 receives I and Q signals 30, 31. In this example, each signal 30, 31 is in the form of a digital 6-bit signed word capable of representing a magnitude with values from −31 to 31.

A first circuit 43 takes samples 44, 45 of the I and Q signals 30, 31. In this example, the signals 30, 31 are oversampled, preferably by a factor of 5.

Samples of I and Q 44, 45 are fed into a second circuit 46 (the operation performed by 46 may be performed in software, hardware or a combination thereof) which calculates power, P, for example by adding the squares of the magnitudes the values of I and Q 44, 45, i.e. P=I²+Q². The samples are then averaged to obtain an average power value <P>. In this example, an average is taken over 80 samples per symbol. The average value is output as a power level 47.

A third circuit 48 compares the power level value 47 with a reference power level value 49 and produces an error value 50, for example by subtracting the reference power level value 49 from the power level value 47, i.e. ΔP=P−P_{ref.}

A fourth circuit 51 (the operation performed in 51 may be performed in software, hardware or a combination thereof) receives the error value 50 and, dependent upon the size of the error value 50, changes a counter 52 from which a counter value 53 is read-out (see the first adjustment). In this case, the counter 52 is a 5-bit register. As will be explained in more detail later, the counter 52 has a range of 0 to 27, i.e. 0≦N≦27, each step representing a change of power of 3 dB.

A fifth circuit 54 (the operation performed in by 54 may be performed in software, hardware or a combination thereof) decodes the read-out value 53 into corresponding control signals 35, 36, 37, in the form of binary word signals, for controlling the gain of the amplifiers 17, 26, 27. The control signals 35, 36 for the baseband amplifiers 26, 27 are given in terms of a baseband gain factor. The control signal for the LNA 17 is given in terms of low, medium or max gain.

The decode rule is as follow (ref FIG. 7, initial Mid setting of LNA at the beginning of each slot):

Firstly LNA switch:
If (Counter@53<=GainMaxToMid && LNA=Max) switch LNA=Mid
If (Counter@53>=GainMidToMax && LNA=Mid) switch LNA=Max
If (Counter@53<=GainMidToLow && LNA=Mid) switch LNA=Low
If (Counter@53>=GainLowToMid && LNA=Low) switch LNA=Mid

Secondly BB amplifier gain compensation:
If (LNA=Max) Counter@17=Counter@53 (i.e. no compensation at BB when LNA Max)
If (LNA=Mid) Counter@17=4+Counter@53 (i.e. LNA Mid is 12 dB below LNA Max)
If (LNA=Low) Counter@17=4+5+Counter@53 (i.e. LNA Low is 15 dB below LNA Mid)

Finally BB amplifier gain switch
If (Counter@17>9) Counter@17=Counter@17−9 (i.e. hysteresis=9)
Else Counter@17=0

Referring to FIG. 6, the dynamic range of an analog-to-digital converter 28, 29 is illustrated.

The reference power level value 49 is arranged to provide headroom below a full-scale signal level 55 and lies above a quantisation noise level 56. In this example, the dynamic range of each analog-to-digital converter 28, 29 is 33 dB. 15 dB of headroom is provided which comprises 9 dB to account for the peak-to-average ratio of the transmitted signal and 6 dB to allow for fading uncertainty for the rest of timeslot 40. The reference power level 49 may be arranged to provide mote or less headroom according to empirical measurements of the radio network.

Referring to FIG. 7, the dynamic range of the direct conversion receiver is 81 dB and is controlled using the counter 52 in 3 dB steps. Adjusting the value of counter 52 changes the gain of the amplifiers 17, 28, 29. For example, the LNA 17 has three selectable fixed gains, namely max, medium and low.

As explained earlier, the range lies between standard/product defined maximum and minimum signal levels which the receiver may be expected to receive and which may be derived from a telecommunications standard.

A method of operating the automatic gain control circuit 34 will now be described in more detail:

Referring to FIGS. 4 to 8, the counter 52 is initially set a mid-range value, preferably N=14. This causes the fifth circuit 54 to send a control signal 37 to LNA 17 setting it to a medium gain (step S1).

A first adjustment, or stage, is performed:

The first circuit 43 takes samples of the outputs 30, 31 of the analog-to-digital converters 28, 29 at the beginning of a slot 40 (step S2). In this case, the circuit 43 oversamples by a factor of 5 over 16 chips 41 which corresponds to one symbol 42. Thus, 80 samples are taken for one symbol 42. The second circuit 46 determines a value of power 47, which is fed into the third circuit 48 to be compared with the reference power level 49 and so determine an error value 50 (steps S3 & S4).

It is then determined whether the power level 47 falls within a predetermined range, in this example corresponding to the dynamic range of the analog-to-digital converters 28, 29.

The fourth circuit 51 examines the error value ΔP and checks whether it exceeds a first error threshold ΔP₁ (step S5). If the first error threshold ΔP₁ is exceeded, indicating that the power level 45 is above the full scale signal level 55 of the analog-to-digital converters 28, 29, then a first large value ΔN₁ is deducted from the counter 52 (step S6). In this example, the first large value ΔN₁ is 9 and corresponds to a gain reduction of 27 dB. The fifth circuit 54 reads out the value of the counter 52 and the LNA 17 switches from medium to low gain.

If the error value ΔP does not exceed the first error threshold ΔP₁, the fourth circuit 53 checks whether it falls below a second error threshold ΔP₂, wherein ΔP₁>ΔP₂ (step S7). If the second error threshold is not exceeded, indicating that power level 47 is below the quantisation noise level 56 of the analog-to-digital converters 28, 29, then a second large value ΔN₂ is added to the counter 52 (step S8). In this example, second large value ΔN₂ is 9 and corresponds to a gain increase of 27 dB. The fifth circuit 54 reads out the value of the counter 52 and the LNA 17 switches from medium to high gain.

FIG. 9 shows a signal power level 57 which exceeds the full-scale sigma value 55 of an analog-to-digital converter. The gain is decreased such that the adjusted signal power level 57′ falls below the full-scale sigma value 55 and within the dynamic range of the analog-to-digital converter, as shown by the shaded region.

A second adjustment, or stage, of the process is performed:

The first circuit 43 takes samples of the outputs 30, 31 of the analog-to-digital converters 28, 29 over 16 chips 41 of the next symbol 42 (step S9). The second circuit 46 determines another value of power 47, which is fed into the third circuit 48 to be compared with the reference power level 49 and so determine another error values ΔP (steps S10 & S11).

The fourth circuit 48 adjusts the value of the counter 52 according to the error value ΔP (step S12). In this case, an error value is computed because the power of the signals fall within the dynamic range of the analog-to-digital converters 28, 29. Thus, a third value ΔN₃ may be computed which is related to the error value ΔP and added or subtracted from the counter 52 with the purpose of producing a substantially zero error value.

According to the second stage of the process, the adjusted power levels which now fall within the 32 dB dynamic range are further adjusted until they reach the reference level 49. This is illustrated in FIG. 9, which shows the gain being decreased such that a further adjusted signal power level 57″ converges on the reference level 49.

As mentioned previously, the AGC algorithm involves two learning iterations, and at most one LNA switch for each slot. These are detailed below:

Initial settings are LNA(17)=Mid, Rx_dB_counter (53)=14, thus BBAmp_dB_counter(17)=14+4−9=9,

Two learning iterations

If the signal power falls within the ADC dynamic range, the power adjustments are based on the difference between the received power and the A/D reference level. However, if the signal power is above ADC full scale or below quantisation noise level, the first power measurement cannot represent the exact input signal level:

(a) When the power is clipped for the first measurement, then the Rx dB (power) counter (53) goes down for 9 points corresponding to a gain deduction of 27 dB always, and LNA switches to the low gain. This results in

LNA=Low, and RX_dB_counter (53)=14−9=5,

BBAmp_dB_counter(17)=5+9−9=5;

After first learning, the signal is within [−12 dB, +15 dB] of the reference, the difference determines the gain adopted for BBAmp (26, 27) on the second learning:

For one extreme, the signal is 12 dB below reference level, then LNA remain Low, RX_dB_counter(53)=5+4, BBAmp_dB_counter (17)=9;

For the other extreme, the signal is 15 dB above reference level, then LNA remain low, and Rx_dB_counter(53)=5−5, BBAmp_dB_counter (17)=0;

(b) When the power of the first measurement is far below quantization noise level, the Rx dB counter goes up to 9 points corresponding to a gain increase of 27 dB always, and LNA switches to the Max gain. This results in LNA=Max, and RX_dB_counter(53)=14+9=23, BBAmp_dB_counter(17)=23−9=14;

After first learning, the signal is within [−12 dB, +9 dB] of the reference, the difference determines the gain adopted for BBAmp (26, 27) on the second learning:

For one extreme, the signal is 12dB below refernces level, then LNA remain Max, RX_dB_counter(53)=23+4, BBAmp_dB_counter (17)=27−9=18;

For the other extreme, the signal is 9 dB above reference level, then LNA remain Max, and Rx_dB_counter(53)=23−3, BBAmp_dB_counter (17)=20−9=11;

Note that if the average power of signal is exactly 15 dB above reference level, the measured average power will be short than that due to the clipping effect. For this reason, the second learning should be always applied even if the signal power falls within the ADC dynamic range in the first learning, and on the second learning the average signal power is taken as clipped when a measured one is, say 1 or 2 dB below the full scale. Thus, the second iteration is guaranteed to put the input power level back to the reference level, which is 15 dB below full scale. Here, of the 15 dB reserved for a headroom, 9 dB accounts for PAR (Peak to Average to ratio), and 6 dB accounts for the fading uncertainty for the rest of the slot.

To reduce the power variation at the training period, it is also recommended for TDD that single channelization code be used for two symbols at the beginning of each slot, i.e. two preambles for TDD slot. These two symbols (16 chips each) are employed for AGC training only. Since PAR are reserved already in the headroom of A/D converter, it is therefore important for AGC to acquire the mean power of the received signal.

Thus, the two-stage process has the advantage that it quickly and accurately adjusts the power level of the signals fed into each analog-to-digital converter 28, 29 (FIG. 3).

Only one LNA switch for each slot

Setting the LNA at middle gain to start with each slot (see FIG. 7), it takes a power variation of at least (12-1.5) dB to switch the LNA. Since it is almost impossible for the power variation between the first and second learning iteration using two consecutive symbols to be as large, thus LAN switch only happen once at most.

A reason for the swiftness of process is that in order to acquire a proper gain, a signal is adapted in a manner with two iterations and one LNA switch at most. In this example, adapting the signal comprises switching the gain LNA 17 (FIG. 3) either once or not at all per timeslot 40 (FIG. 4). Swiftness is particularly useful in handset receiver for use in a WCDMA TDD system because if gain is not acquired quickly, then a loss of link performance will occur.

A reason for the accuracy of the process is that having adapted the signal in the predetermined manner, the adapted signal becomes measurable and thus can be further adapted as necessary.

It will be appreciated that many modifications may be made to the embodiment described above. The direct conversion receiver may comprise a single channel and have a single LNA, a single baseband amplifier and a single analog-to-digital converter, wherein power levels are calculated using the signal output from the analog-to-digital converter. The receiver need not be a direct conversion receiver, but may be a superheterodyne receiver. The receiver may be used in a handset which conforms to other standards including other 3 g standards, such as CDMA2000, 2 g standards, such as GSM, or 1 g standard. Other standards include derivative standards, such as a 2.5 g standard, for example EDGE GSM. Another signal level, such as signal voltage or signal amplitude, may be used instead of signal power. Accordingly, another reference signal, such as a reference voltage signal level or reference amplitude signal level may be used.

1. A gain control circuit for causing a power level of a signal to converge on a power level reference signal, said circuit being arranged, in a first adjustment, to determine whether the power level of said signal falls within a predetermined range containing the power level reference signal and, if not, to adapt said signal in a manner predetermined to cause the power level of said adapted signal to fall within said predetermined range and, in a second adjustment, to measure the power level of said adapted signal and to further adapt said adapted signal using the measured power level of said adapted signal thereby causing the power level of said further adapted signal to converge on the power level of said reference signal.

2. A gain control circuit according to claim 1 arranged such that convergence of the power level of the signal on the power level reference signal is achieved by adapting said signal in the predetermined manner and further adapting the adapted signal.

3. A gain control circuit according to claim 1 arranged to determine whether the power level of said signal falls within the predetermined range containing the power level reference signal by checking whether the power level has clipped.

4. A gain control circuit according to claim 1 arranged to determine whether the power level of said signal falls within the predetermined range containing the power level reference signal by determining whether an average power level of said signal falls within another predetermined range.

5. A gain control circuit according to claim 4, wherein said another measurement range provides a measurement range limit tolerance to take account of signal averaging errors.

6. A gain control circuit according to claim 1 arranged to adapt the power level of said signal by a predetermined amount.

7. A gain control circuit according to claim 1 arranged to adapt the power level of said signal by causing a change in gain by a predetermined factor.

8. A gain control circuit according to claim 7 arranged to adapt the power level of said signal by selecting a one of a plurality of fixed gains of an amplifier.

9. A gain control circuit according to claim 7 arranged to adapt the power level of said signal by selecting a one of three fixed gains of an amplifier.

10. A gain control circuit according to claim 9 arranged initially to select a first fixed gain having an intermediate gain and thereafterto adapt the power level of said signal by selecting a second, lower or a third, higher fixed gain.

11. A gain control circuit according to claim 1 arranged to measure the power level of said adapted signal by comparing the power level of said adapted signal with the power level reference signal so as to determine an error value.

12. A gain control circuit according to claim 11 arranged to further adapt said adapted signal by causing a change in gain related to the error value.

13. A gain control circuit according to claim 1 arranged to adapt said signal using a relatively coarse adjustment and to further adapt said adapted signal using a relatively fine adjustment.

14. A gain control circuit according to claim 1, wherein said signal includes first and second consecutive signal portions and wherein the gain control circuit is arranged to determine during the first signal portion whether the power level of said signal falls within the predetermined range containing the power level reference signal and, if not, to adapt said signal in the predetermined manner thereby causing the power level of said adapted signal to fall within said predetermined range and to measure during the second signal portion the power level of said adapted signal and to further adapt said adapted signal using the measured power level of said adapted signal thereby causing the power level of said further adapted signal to converge on the power level of said reference signal.

15. A gain control circuit according to claim 1 for controlling first and second amplifiers.

16. A gain control circuit according to claim 15, including first and second outputs for controlling gains of said first and second amplifiers respectively.

17. A gain control circuit according to claim 15, configured to instruct said first amplifier to change gain so as to adapt said signal in the predetermined manner.

18. A gain control circuit according to claim 17, configured to instruct said second amplifier to change gain so as to further adapt said adapted signal.

19. A gain control circuit according to any once of claims 15, configured to instruct said first amplifier to change gain only once during said first and second adjustments.

20. A gain control circuit according to claim 1, wherein the predetermined range is a gain control circuit measurement range.

21. A gain control circuit according to claim 20, wherein said measurement range is a range which is reliably measured.

22. A gain control circuit according to claim 20, wherein said measurement range includes a positive limit and a zero limit.

23. A gain control circuit according to claim 20, wherein said measurement range includes a positive limit and a negative limit.

24. A gain control circuit according to claim 1, which is arranged, in the first adjustment, to appropriately adapt said signal by an amount corresponding to a standard/product defined maximum magnitude of the signal outside a proximal measurement range limit so as to bring the signal within the measurement range.

25. A gain control circuit according to claim 1 conforming to a 1^{st}, 2^{nd}, 3^{rd} or 4^{th} generation telecommunications standard or a derivative standard, wherein a maximum standard/product defined signal magnitude is derived from said standard.

26. A gain control circuit according to claim 1, which is arranged, in the first adjustment, to adapt said signal by a different amount according to which predetermined range limit the signal is outside.

27. A radio receiver including a gain control circuit according to claim 1 and further including first and second amplifiers.

28. A radio receiver according to claim 27, wherein the gain control circuit is arranged to determine whether the power level of said signal falls within the predetermined range by checking whether an output of said component has clipped.

29. A radio receiver according to claim 27, wherein the gain control circuit is arranged to check a predetermined number of samples of said output of said component.

30. A gain control circuit or radio receiver according to according to claim 1 wherein the predetermined range is a dynamic range of an electric component or circuit.

31. A gain control circuit or radio receiver according to claim 1 configured to cause the power level of the signal to converge on the power level reference signal using no more than two adjustments.

32. (canceled)

33. A method of gain control for causing a power level of a signal to converge on a power level of a reference signal, the method comprising:
in a first adjustment: determining whether the power level of said signal falls within a predetermined range containing the power level reference signal and, if not, adapting said signal in a manner predetermined to cause the power level of said adapted signal to fall within said predetermined range and,
in a second adjustment: measuring the power level of said adapted signal and further adapting said adapted signal using the measured power level of said adapted signal thereby causing the power level of said further adapted signal to converge on the power level of said reference signal.

34. A method of gain control according to claim 33 using no more than two adjustments.

35. (canceled)

36. A computer program for performing the method of claim 33.
